(19) United States
(12) Patent Application Publication
(10) Pub. No.: US 2022/0290619 A1
(43) Pub. Date: Sep. 15, 2022

(54) FUEL SUPPLY SYSTEM

(71) Applicant: HONDA MOTOR CO., LTD., Tokyo (JP)

(72) Inventor: Akira Ota, Wako-shi (JP)

(21) Appl. No.: 17/686,449

(22) Filed: Mar. 4, 2022

(30) Foreign Application Priority Data
Mar. 15, 2021 (JP) 2021-041178

(51) Int. Cl. F02C 9/26; F02C 7/232

(52) U.S. Cl. CPC F02C 9/26; F02C 7/232; F05D 2220/32

(57) ABSTRACT

A fuel supply system 1 includes an ecology device 6 that includes a first passage 11 and a second passage 12, a cylinder 10 and a piston 14 provided between the first passage 11 and the second passage 12, an urging portion 15 that urges the piston 14, and a third passage 13 that branches off from the first passage 11. A volume A1 of the first space 31 of the cylinder 10 at the time of the engine operation of the gas turbine engine is defined as a first volume when operating B1. A total volume of fuel remaining in a fuel manifold 4 and a fuel nozzle 5 at the time of the engine stop of the gas turbine engine is defined as a required recovery volume D. The first volume when operating B1 is greater than the required recovery volume D.

### CROSS-REFERENCE TO RELATED APPLICATION

Priority is claimed on Japanese Patent Application No. 2021-041178 filed Mar. 15, 2021, the content of which is incorporated herein by reference.

### BACKGROUND OF THE INVENTION

### Field of the Invention

The present invention relates to a fuel supply system.

### Description of Related Art

In a gas turbine engine used for an aircraft or the like, a fuel supply system having a fuel manifold for supplying fuel to a fuel nozzle is known. In the fuel supply system, at the time of engine stoppage, the fuel remaining in the fuel nozzles becomes coke, which may cause deterioration in efficiency of the engine and damage to a combustor. Therefore, in the fuel supply system, various techniques for recovering the residual fuel in the fuel manifold at the time of engine stop have been proposed.

For example, Patent Document 1 (Japanese Unexamined Patent Application, First Publication No. 2013-11276) discloses an ecology valve (an ecology device) for recovering and storing the fuel from a fuel manifold, which is configured to include a cylinder communicating with each of a fuel pump and the fuel manifold, a piston that slides inside the cylinder between an operating position at the time of engine operation and a discharging position at the time of engine stoppage, and a muscle valve through which a flow path on an outlet side and a flow path on an inlet side of the cylinder communicate with each other.

According to the technique described in Patent Document 1, because the piston moves to increase a capacity inside the cylinder at the discharging position, the residual fuel in the fuel manifold can be recovered and stored in the cylinder.

However, in the technique described in Patent Document 1, a relationship between a volume of the cylinder and the fuel capacity is not specified in detail. When the volume of the cylinder is smaller than the capacity of the residual fuel, the residual fuel in the fuel nozzle and the fuel manifold cannot be sufficiently recovered, which may cause coking of the fuel nozzle. On the other hand, when the volume of the cylinder is too large with respect to the capacity of the residual fuel, an increase in size of the entire fuel supply system and a cost increase may be caused. Therefore, the related art has a problem in terms of optimizing the cylinder volume and curtailing increase in size of the fuel supply system.

Further, in the technique described in Patent Document 1, the residual fuel recovered at the time of engine stoppage flows into both spaces inside the cylinder partitioned by the piston. At this time, a part of the combustion gas may be recovered together with the residual fuel. Therefore, the recovered combustion gas may oxidize the components inside the cylinder, resulting in deterioration of the components.

Therefore, an object of the present invention is to provide a fuel supply system that is capable of suppressing an increase in size and suppressing the deterioration of components by optimizing the cylinder volume.

### SUMMARY OF THE INVENTION

In order to solve the above problems, the fuel supply system according to the present invention has the following configuration.

(1) According to an aspect of the present invention, a fuel supply system of a gas turbine engine is provided, the fuel supply system including a fuel tank; a fuel manifold which supplies a fuel from the fuel tank to a fuel nozzle; and an ecology device provided between the fuel tank and the fuel manifold to recover the fuel from the fuel manifold, in which the ecology device includes a first passage connected to the fuel tank, a second passage connected to the fuel manifold, a cylinder which is provided between the first passage and the second passage and has a first port communicating with the first passage and a second port communicating with the second passage, a piston which partitions an internal space of the cylinder into a first space communicating with the first passage and a second space communicating with the second passage, and slides inside the cylinder, a biasing portion which biases the piston from the second port side toward the first port side, a third passage which branches off from the first passage and communicates with the second passage, and a check valve which is provided in the third passage to block circulation from the second passage to the first passage, a volume of the cylinder is equivalent to a total volume of the first space and the second space, the volume of the first space of the cylinder at the time of engine operation of the gas turbine engine is defined as a first volume when operating, and when a total volume of the fuel manifold and the fuel nozzle is set as a required recovery volume at the time of engine stop of the gas turbine engine, the first volume when operating is greater than the required recovery volume.

(2) In the fuel supply system according to the aspect (1), the first volume when operating may be determined by a balance between a pressure difference between the first space and the second space and a biasing force of the urging portion at the time of engine operation, and a magnitude of the urging force of the urging portion may be set such that the first volume when operating is greater than the required recovery volume.

(3) In the fuel supply system according to the aspect (1), the fuel supply system may include a stopper which is provided in the second space and restricts the movement of the piston to the second port side, the piston may abut on the stopper at the time of engine operation, the volume of the first space of the cylinder when the piston abuts the stopper may be defined as the first volume when operating, and the stopper may be provided at a position at which the first volume when operating becomes greater than the required recovery volume.

(4) In the fuel supply system according to any one of (1) to (3), the first volume when operating may have a magnitude equivalent to the required recovery volume.

(5) In the fuel supply system according to any one of (1) to (4), the fuel supply system may include an on-off valve provided in the first passage, and the on-off valve may be closed at the time of engine stoppage for a short time.

(6) In the fuel supply system according to any one of (1) to (4), the fuel supply system may include a fourth passage which branches off from the first passage and is connected to the fuel tank; and a selection switching valve which is able to switch between the first passage and the fourth passage, at the time of engine operation, and the selection switching valve may be controlled such that the fuel flows through the first passage and is supplied to the ecology device, and at the time of the engine stop, the selection switching valve may be controlled such that the fuel recovered by the ecology device flows through the fourth passage and is returned to the fuel tank.

(7) In the fuel supply system according to the aspect (5), the fuel supply system may include a fourth passage which branches off from the first passage and is connected to the fuel tank; and a selection switching valve which is able to switch the first passage and the fourth passage, at the time of engine operation, the selection switching valve may be controlled such that the fuel flows through the first passage and is supplied to the ecology device, at the time of the engine stop, the selection switching valve may be controlled such that the fuel recovered by the ecology device flows through the fourth passage and is returned to the fuel tank, and a three-way valve in which the on-off valve and the selection switching valve are integrated may be provided at a connection portion between the first passage and the fourth passage.

According to the aspect (1), the ecology device is provided between the fuel tank and the fuel manifold, and the ecology device includes the first passage, the second passage, the cylinder having the first port and the second port, the piston, the urging portion, and the third passage having the check valve. The piston partitions the internal space of the cylinder into a first space and a second space. At the time of the engine operation, the fuel supplied from the fuel tank flows through the third passage and is supplied to the fuel manifold, and the piston moves to the second port side due to the fuel flow rate discharged from the fuel pump. The volume of the first space at this time is the first volume at the time of operation. On the other hand, at the time of the engine stop, because the fuel flow rate discharged from the fuel pump decreases, the piston moves to the first port side. As a result, because the second space has a negative pressure, the residual fuel in the fuel nozzle connected to the second space of the cylinder via the second port and the second passage is recovered in the second space of the cylinder. Therefore, the residual fuel can be recovered at the time of the engine stop and coking of the fuel nozzle can be suppressed.

The first volume when operating, which is the volume of the first space at the time of the engine operation, is greater than the required recovery volume, which is the total amount of fuel in the fuel manifold and the fuel nozzle. Here, the volume of residual fuel that can be recovered by the ecology device is equal to the volume of the second space that increases with the movement of the piston. In the aspect of the present invention, the volume of the cylinder is equal to the total volume of the first space and the second space partitioned by the piston. Therefore, the volume of the second space increased by the movement of the piston, that is, the volume of the recoverable residual fuel is equal to the volume of the first space decreased by the movement of the piston. According to the aspect of the present invention, since the first volume when operating is greater than the required recovery volume, the residual fuel can be reliably recovered by moving the piston to narrow the first space at the time of the engine stop. The size of the first space can be set depending on the volume of the residual fuel. This makes it possible to optimize the cylinder volume and prevent the cylinder from becoming excessively large. Further, since the recovery function can be realized by one cylinder and piston, the configuration can be simplified, and the size and weight can be reduced as compared with the related art in which a muscle valve is provided in addition to the cylinder and the piston.

The recovered residual fuel is accommodated only in the second space and does not flow into the first space or the first passage. Therefore, for example, even if the combustion gas is mixed in at the time of recovery of the residual fuel, it is possible to prevent the combustion gas from entering the supplying flow path on the fuel pump side. Accordingly, since a region with which the combustion gas comes into contact can be reduced to a minimum size, oxidation or the like due to the combustion gas can be curtailed, and deterioration of components can be curtailed.

Therefore, it is possible to provide a fuel supply system in which increase in size and deterioration of components can be curtailed, due to the volume of the cylinder being optimized.

According to the aspect (2), the first volume when operating is determined by the balance between the pressure difference between the first space and the second space and the urging force of the urging portion at the time of the engine operation. In the urging portion, the magnitude of the urging force is set such that the first volume when operating is greater than the required recovery volume. By setting the urging force of the urging portion in this way, it is possible to automatically secure the first volume when operating in a desired magnitude, by balance of both forces at the time of the engine operation. Therefore, for example, it is not necessary to provide a control system or the like for electrically controlling the position of the piston, and the configuration of the fuel supply system can be simplified.

According to the aspect of (3), the piston abuts on the stopper provided in the second space at the time of the engine operation. The stopper is provided at a position at which the volume (the first volume when operating) of the first space of the cylinder becomes greater than the required recovery volume when the piston abuts the stopper. As a result, it is possible to stably secure the first volume when operating of a desired magnitude at the time of the engine operation, without being affected by fluctuations in pressure in the fuel pump. Therefore, at the time of the engine stop, all the residual fuel can be recovered more reliably.

According to the aspect of (4), the first volume when operating has a magnitude equivalent to that of the required recovery volume. This makes it possible to further optimize the cylinder volume, while reliably recovering the residual fuel. Therefore, the size of the cylinder can be kept to a minimum, and further miniaturization, weight reduction, and cost reduction of the fuel supply system can be obtained.

According to the aspect of (5), the on-off valve is provided in the first passage, and the on-off valve is closed at the time of the engine stop for a short time. Here, for example, in some cases, the engine may unintentionally misfire and the engine may be stopped for a short time. In such a case, since it is necessary to restart the engine immediately, it is desirable to keep the fuel in the fuel manifold and the fuel nozzle without recovering the fuel. According to the aspect of the present invention, since both the first passage and the fourth passage on the fuel pump side are closed by closing the on-off valve, the piston does not move to the first port side even at the time of the engine stop. Therefore, because the fuel is not recovered and the fuel remains in the fuel manifold and the fuel nozzle, the engine can be restarted quickly. Further, the versatility of the fuel supply system can be improved, by switching between the presence or absence of the recovery operation in accordance with the length at the time of the engine stop.

According to the aspect of (6), the fuel supply system includes a fourth passage and a selection switching valve. The selection switching valve is controlled such that the fuel flows through the first passage at the time of the engine operation, and the fuel flows through the fourth passage at the time of the engine stop. In this way, the flow path through which the fuel flows differs between the time of the engine operation (at the time of supply of fuel) and the time of the engine stop (at the time of recovery of fuel). Therefore, for example, even when a one-way fuel pump is used, the fuel can be supplied and recovered without wearing the pump. Because the supply path and the recovery path of the fuel are different, it is easy to manage the supply amount and the recovery amount of fuel. Therefore, the amount of fuel supplied from the fuel tank to the fuel nozzle can be controlled more precisely.

According to the aspect of (7), the on-off valve and the selection switching valve are an integrated three-way valve. Therefore, the above-mentioned effects can be obtained by each valve with a simple configuration. Since it is not necessary to provide a plurality of valves on the passage, the space for installing the valve can be saved and the passage can be shortened. Therefore, it is possible to suppress an increase in weight and an increase in size of the fuel supply system.

### BRIEF DESCRIPTION OF THE DRAWINGS

FIG. 1 is a schematic configuration diagram of a fuel supply system according to a first embodiment.

FIG. 2 is a diagram showing an operation at the time of the fuel recovery of the fuel supply system according to the first embodiment.

FIG. 3 is a schematic configuration diagram of the fuel supply system according to a second embodiment.

FIG. 4 is a schematic configuration diagram of the fuel supply system according to a third embodiment.

FIG. 5 is a diagram showing an operation at the time of the fuel recovery of the fuel supply system according to the third embodiment.

FIG. 6 is a diagram showing an operation at the time of the engine stop for a short time in the fuel supply system according to the third embodiment.

### DETAILED DESCRIPTION OF THE INVENTION

Hereinafter, embodiments of the present invention will be described referring to the drawings.

### First Embodiment

### (Fuel Supply System)

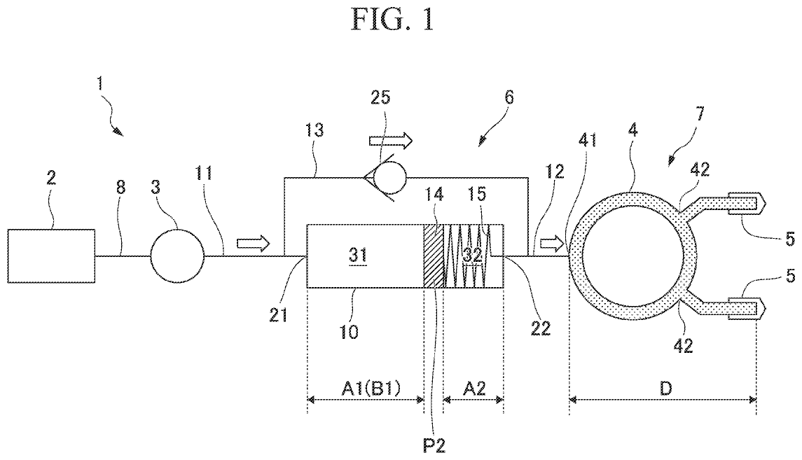

FIG. 1 is a schematic configuration diagram of a fuel supply system 1 according to a first embodiment. FIG. 1 is a diagram showing an operation when fuel is supplied to a combustor of an engine (at the time of the engine operation).

The fuel supply system 1 is a system for supplying a fuel to a combustion chamber (not shown) of, for example, a gas turbine hybrid engine, a gas turbine engine, or the like (hereinafter, in some cases, simply referred to as an engine) mounted on an aircraft or the like (not shown). The fuel supply system 1 supplies the fuel stored in the fuel tank 2 to a fuel nozzle 5 for supplying the fuel to the combustion chamber, for example, at the time of the engine operation. The fuel supply system 1 is capable of recovering at least the fuel remaining in the fuel nozzle 5 at the time of the engine stop. The fuel supply system 1 includes a fuel tank 2, a fuel supply unit 7, and an ecology device 6.

The fuel tank 2 stores the fuel. The fuel tank 2 is connected to a fuel pump 3 via a connecting pipe 8. That is, the fuel tank 2 is connected to one end portion of the connecting pipe 8, and the fuel pump 3 is connected to the other end portion of the connecting pipe 8. The fuel pump 3 is, for example, an electric pump that is driven by electric power from a battery (not shown). The fuel pump 3 sucks the fuel from the fuel tank 2 and supplies the fuel to the ecology device 6 and the fuel supply unit 7.

The fuel supply unit 7 is connected to the fuel tank 2 (fuel pump 3) via an ecology device 6, which will be described in detail later. Fuel is supplied to the fuel supply unit 7 from the fuel tank 2. The fuel supply unit 7 supplies the fuel circulated from the fuel tank 2 to the combustion chamber of the engine. The fuel supply unit 7 has a fuel nozzle 5 and a fuel manifold 4.

At least a part of the fuel nozzle 5 communicates with the combustion chamber and injects and supplies the fuel into the combustion chamber at the time of the engine operation. In the present embodiment, a plurality of fuel nozzles 5 are provided. The fuel manifold 4 is disposed on an upstream side of the fuel nozzle 5 in a circulation direction of fuel. The fuel manifold 4 supplies fuel from the fuel tank 2 to each of the plurality of fuel nozzles 5. The number of fuel manifolds 4 is smaller than that of the fuel nozzles 5. In the present embodiment, one fuel manifold 4 is provided for each of the plurality of fuel nozzles 5. The fuel manifold 4 is formed in an annular shape. The fuel manifold 4 has an inlet portion 41 into which fuel flows, and a plurality of outlet portions 42 communicating with each of the plurality of fuel nozzles 5. The outlet portions 42 are provided side by side, for example, along a circumferential direction of the annular fuel manifold 4. When the fuel flows out from the plurality of outlet portions 42, the fuel manifold 4 makes it possible to supply fuel to the plurality of fuel nozzles 5 at the same time.

The ecology device 6 is provided between the fuel tank 2 and the fuel supply unit 7 in the circulation direction of fuel. The ecology device 6 supplies fuel to the fuel supply unit 7 at the time of the engine operation and recovers the fuel remaining in the fuel supply unit 7 at the time of the engine stop. Specifically, the ecology device 6 has a cylinder 10, a first passage 11, a second passage 12, a third passage 13, a piston 14, and an urging portion 15.

The cylinder 10 is formed to have a space of a predetermined size inside. The size of the internal space of the cylinder 10 will be described below in detail. The cylinder 10 has a first port 21 provided at an end portion, and a second port 22 provided at the end portion opposite to the first port 21. The first port 21 communicates with the first passage 11. The second port 22 communicates with the second passage 12. That is, the cylinder 10 is provided between the first passage 11 and the second passage 12.

The first passage 11 connects the first port 21 of the cylinder 10 to the fuel tank 2 (more specifically, the fuel pump 3). The first passage 11 communicates with each of the first port 21 of the cylinder 10 and the fuel pump 3. Therefore, the fuel sucked from the fuel tank 2 by the fuel pump 3 flows through the first passage 11 and flows into the cylinder 10 from the first port 21. The second passage 12 connects the second port 22 of the cylinder 10 and the inlet portion 41 of the fuel manifold 4. The second passage 12 communicates with each of the second port 22 of the cylinder 10 and the fuel manifold 4. Therefore, the fuel in the cylinder 10 flows through the second passage 12 and flows into the fuel manifold 4.

The third passage 13 branches off from the first passage 11 and communicates with the second passage 12. In other words, the third passage 13 connects the first passage 11 and the second passage 12 without going through the cylinder 10. A check valve 25 is provided in the third passage 13. The check valve 25 permits circulation from the first passage 11 to the second passage 12, and blocks circulation from the second passage 12 to the first passage 11.

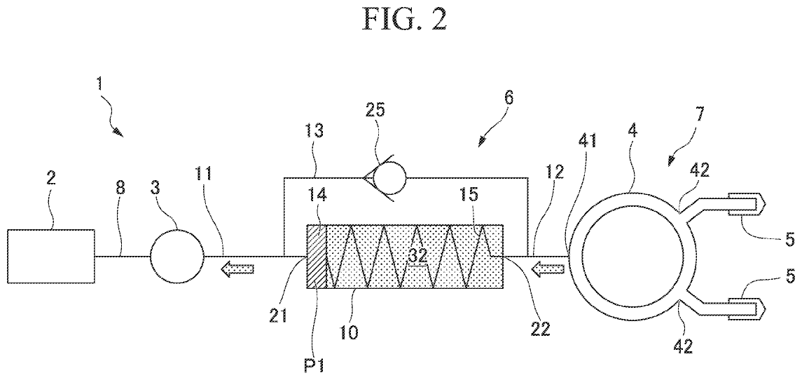

The piston 14 is provided inside the cylinder 10. The piston 14 is configured to be slidable inside the cylinder 10. The piston 14 partitions the internal space of the cylinder 10 into a first space 31 communicating with the first passage 11, and a second space 32 communicating with the second passage 12. The piston 14 blocks the circulation of fuel between the first space 31 and the second space 32. That is, the first space 31 and the second space 32 are independent spaces of each other with the piston 14 interposed therebetween. The piston 14 slides between a first position P1 (see FIG. 2) located on the first port 21 side and a second position P2 located on the side closer to the second port 22 than the first position P1. The first position P1 is a stop position of the piston 14 when the residual fuel of the fuel supply unit 7 is recovered by the ecology device 6 at the time of the engine stop. The second position P2 is a stop position of the piston 14 when the ecology device 6 supplies the fuel from the fuel tank 2 to the fuel supply unit 7 at the time of the engine operation.

In the present embodiment, the first position P1 is a position when the piston 14 abuts on the end portion of the cylinder 10 on the first port 21 side. That is, when the piston 14 is located at the first position P1, the first position P1 is set such that a volume A1 of the first space 31 becomes zero. The second position P2 is a position closer to the second port 22 than a central portion of the cylinder 10 in a longitudinal direction of the cylinder 10 (a direction along a movement direction of the piston 14).

The urging portion 15 is provided inside the second space 32 of the cylinder 10. The urging portion 15 is, for example, a spring. The urging portion 15 connects the end portion of the cylinder 10 on the second port 22 side with the piston 14. The urging portion 15 urges the piston 14 from the second port 22 side toward the first port 21 side. The urging portion 15 (spring) is in a most contracted state when the piston 14 is at the second position P2 and is in a most expanded state when the piston 14 is at the first position P1.

### (Volume of Cylinder)

In the ecology device 6 configured as described above, the magnitude of the volume of the cylinder 10 will be described below in detail. The volume of the cylinder 10 is the same as the total of the volume A1 of the first space 31 and the volume A2 of the second space 32. The volume A1 of the first space 31 and the volume A2 of the second space 32 gradually change inversely proportion to each other due to the movement of the piston 14, but the volume of the entire cylinder 10 (that is, the total of the volume A1 of the first space 31 and the volume A2 of the second space 32) is, in principle, a constant value regardless of the position of the piston 14.

Here, at the time of the engine operation, the piston 14 is located at the second position P2. The volume A1 of the first space 31 of the cylinder 10 at this time is called a first volume when operating B1. At the time of the engine stop, the total volume of fuel that can remain in the fuel manifold 4 and the fuel nozzle 5 is defined as a required recovery volume D. The volume of the piston 14 is set such that the first volume when operating B1 is equal to or larger than the required recovery volume D (B1≥D). Further, the volume of the piston 14 is preferably set such that the first volume when operating B1 approaches a value equivalent to the required recovery volume D within the range satisfying the above-mentioned condition of B1≥D. In the present embodiment, the volume of the cylinder 10 is set such that the first volume when operating B1 is equal to the same magnitude of the required recovery volume D (B1=D).

### (Urging Force of Urging Portion)

Next, the magnitude of the urging force of the urging portion 15 provided in the second space 32 will be described. The above-mentioned first volume when operating B1 is the volume A1 of the first space 31 when the piston 14 is located at the second position P2. The second position P2 is determined by a balance between a fuel pressure from the fuel tank 2 flowing into the first space 31 and the urging force of the urging portion 15 at the time of the engine operation. In other words, the first volume when operating B1 coincides with the volume A1 of the first space 31 when a pressure difference between the first space 31 and the second space 32 and the urging force of the urging portion 15 are balanced at the time of the engine operation. In the urging portion 15, the magnitude of the urging force is set such that the first volume when operating B1 is greater than the required recovery volume D. In the present embodiment, the urging force of the urging portion 15 is set such that the first volume when operating B1 is equal to or greater than the required recovery volume D.

### (Operation of Fuel Supply System)

Next, the operation of the fuel supply system 1 will be described. First, the operation when fuel is supplied from the fuel tank 2 to the fuel supply unit 7 via the ecology device 6 (at the time of the engine operation) will be described.

As shown in FIG. 1, at the time of the engine operation, first, when the fuel pump 3 is driven, the fuel flows from the fuel tank 2 into the first passage 11. Part of the fuel that has flowed into the first passage 11 flows from the first port 21 into the first space 31 of the cylinder 10, and the piston 14 is moved to the second port 22 side by the fuel pressure. When the piston 14 reaches the second position P2 at which the fuel pressure and the urging force of the urging portion 15 are balanced, the movement of the piston 14 is almost stopped, and the inflow of fuel into the first space 31 is stopped. After the inflow to the first space 31 is stopped, the pressure rises to the set pressure of the check valve 25, and at the same time, the remaining part of the fuel in the first passage 11 flows through the third passage 13 and flows into the second passage 12. After that, the fuel flows through the inlet portion 41 of the fuel manifold 4 from the second passage 12 and is filled in the fuel manifold 4. Further, the fuel in the fuel manifold 4 is supplied from the outlet portion 42 to each fuel nozzle 5 and is injected into the combustion chamber from a tip portion of each fuel nozzle 5.

FIG. 2 is a diagram showing an operation at the time of the fuel recovery of the fuel supply system 1 according to the first embodiment. The operation when the fuel remaining in the fuel supply unit 7 is recovered by the ecology device 6 (at the time of the engine stop) will be described referring to FIG. 2.

As shown in FIG. 2, at the time of the engine stop when the engine is stopped from the state in which the engine is operating, the drive of the fuel pump 3 is first stopped, and the fuel supply from the fuel tank 2 is stopped. When the fuel pump 3 is stopped, the fuel pressure drops, and as a result, the urging force of the urging portion 15 becomes greater than the fuel pressure. That is, the total pressure of the pressure of the second space 32 and the urging force becomes greater than the pressure of the first space 31. As a result, the piston 14 moves from the second position P2 to the first position P1 on the first port 21 side by the urging force.

When the piston 14 moves to the first port 21 side, since the volume A2 of the second space 32 increases, the inside of the second space 32 becomes a negative pressure. Here, the check valve 25 is provided in the third passage 13, and the circulation of fuel from the second passage 12 to the first passage 11 is blocked. Therefore, when the second space 32 becomes a negative pressure, the residual fuel in the fuel manifold 4 and the fuel nozzle 5 flows into the second space 32. As a result, the residual fuel of the fuel supply unit 7 is recovered in the ecology device 6.

At this time, the volume of fuel recovered in the ecology device 6 is equal to the increase in the volume A2 of the second space 32 which increases by the movement of the piston 14 from the second position P2 to the first position P1. Since the first position P1 is a position at which the volume A1 of the first space 31 becomes zero, the increase in the volume A2 of the increased second space 32 is equal to the volume A1 of the first space 31 at the time of the engine operation (the first volume when operating B1). In the present embodiment, the first volume when operating B1 is equivalent to the total volume of the volume of the fuel manifold 4 and the volume of the fuel nozzle 5. Therefore, the ecology device 6 can recover almost all the fuel in the fuel manifold 4 and the fuel nozzle 5.

### (Operation, Effect)

Next, the operation and effect of the above-mentioned fuel supply system 1 will be described.

According to the fuel supply system 1 of the present embodiment, the ecology device 6 is provided between the fuel tank 2 and the fuel manifold 4, and the ecology device 6 includes the first passage 11, the second passage 12, the cylinder 10 having the first port 21 and the second port 22, the piston 14, the urging portion 15, and the third passage 13 having the check valve 25. The piston 14 partitions the internal space of the cylinder 10 into the first space 31 and the second space 32. At the time of the engine operation, the fuel supplied from the fuel tank 2 flows through the third passage 13 and is supplied to the fuel manifold 4, and the piston 14 moves to the second port 22 side due to the pressure from the fuel tank 2. The volume A1 of the first space 31 at this time is set as the first volume when operating B1. On the other hand, at the time of the engine stop, when the pressure from the fuel tank 2 decreases, the piston 14 moves to the first port 21 side. As a result, since the second space 32 becomes a negative pressure, the residual fuel in the fuel nozzle 5 connected to the second space 32 of the cylinder 10 via the second port 22 and the second passage 12 is recovered in the second spaces 32 of the cylinder 10. Therefore, the residual fuel can be recovered at the time of the engine stop and coking of the fuel nozzle 5 can be suppressed.

The first volume when operating B1, which is the volume A1 of the first space 31 at the time of the engine operation, is greater than the required recovery volume D, which is the total fuel in the fuel manifold 4 and the fuel nozzle 5. Here, the volume of residual fuel that can be recovered by the ecology device 6 is equal to the increase in the volume A2 of the second space 32 that increases by the movement of the piston 14. In the aspect of the present invention, the volume of the cylinder 10 is equal to the total volume A1 of the first space 31 and the volume A2 of the second space 32 partitioned by the piston 14. Therefore, the increase in the volume A2 of the second space 32 that increases by the movement of the piston 14, that is, the volume of the recoverable residual fuel becomes equivalent to the decrease in the volume A1 of the first space 31 that decreases by the movement of the piston 14. According to the aspect of the present invention, since the first volume when operating B1 is greater than the required recovery volume D, when the piston 14 moves to narrow the first space 31 at the time of the engine stop, the residual fuel can be reliably recovered. The size of the first space 31 can be set depending on the volume of the residual fuel. This makes it possible to optimize the volume of the cylinder 10 and prevent the cylinder 10 from becoming excessively large. Further, since the recovery function can be realized by one cylinder 10 and the piston 14, the configuration is simplified, and the size and weight can be reduced, as compared with related art in which a muscle valve is provided in addition to the cylinder 10 and the piston 14.

The recovered residual fuel is accommodated only in the second space 32 and does not flow into the first space 31 or the first passage 11. Therefore, for example, even if the combustion gas is mixed at the time of recovery of the residual fuel, it is possible to prevent the combustion gas from entering the supplying flow path on the fuel tank 2 side. Accordingly, since a region with which the combustion gas comes into contact can be suppressed to a minimum, oxidation or the like due to the combustion gas can be suppressed, and deterioration of components can be suppressed.

Therefore, it is possible to provide the fuel supply system 1 that can suppress the increase in size and the deterioration of components, by optimizing the volume of the cylinder 10.

The first volume when operating B1 is determined by the balance between the pressure difference between the first space 31 and the second space and 32 and the urging force of the urging portion 15 at the time of the engine operation. In the urging portion 15, the magnitude of the urging force is set such that the first volume when operating B1 is greater than the required recovery volume D. By setting the urging force of the urging portion 15 in this way, it is possible to automatically secure the first volume when operating B1 of a desired magnitude, by balance of both forces at the time of the engine operation. Therefore, for example, it is not necessary to provide a control system or the like for electrically controlling the position of the piston 14, and the configuration of the fuel supply system 1 can be simplified.

The first volume when operating B1 has a magnitude equivalent to that of the required recovery volume D. This makes it possible to further optimize the cylinder 10 volume, while reliably recovering the residual fuel. Therefore, the size of the cylinder 10 can be kept to a minimum, and the further miniaturization, weight reduction, and cost reduction of the fuel supply system 1 can be obtained.

### Second Embodiment

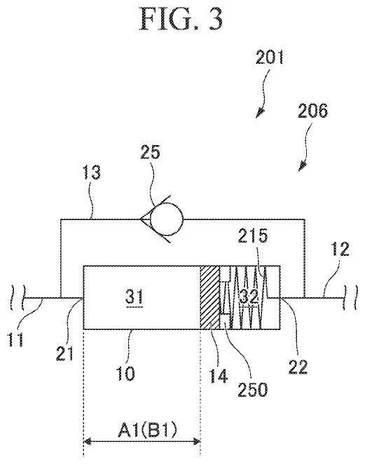

Next, a second embodiment according to the present invention will be described. FIG. 3 is a schematic configuration diagram of a fuel supply system 201 according to the second embodiment. The configurations of the fuel tank 2 and the fuel supply unit 7 in the second embodiment are the same as that those of the first embodiment. Therefore, in FIG. 3, only an ecology device 206 is shown, and the fuel tank 2 and the fuel supply unit 7 are not shown. In the following description, the same configurations as those in the first embodiment described above will be denoted by the same reference numerals, and the description thereof will not be provided as appropriate. The present embodiment differs from the first embodiment described above in that the ecology device 206 further includes a stopper 250.

As shown in FIG. 3, in the present embodiment, the ecology device 206 includes a cylinder 10, a first passage 11, a second passage 12, a third passage 13, a piston 14, an urging portion 215, and a stopper 250. Since the configurations of the cylinder 10, the first passage 11, the second passage 12, the third passage 13, and the piston 14 are the same as those in the first embodiment, the description thereof will not be provided. The urging force of the urging portion 215 of the second embodiment is equivalent to the urging force of the urging portion 15 of the first embodiment.

The stopper 250 is provided in the second space 32 of the cylinder 10. The stopper 250 is provided on the side closer to the second port 22 than the piston 14 and restricts the movement of the piston 14 to the second port 22 side. The stopper 250 is formed, for example, to protrude from the inner wall of the cylinder 10 toward the inside of the cylinder 10. The stopper 250 may be configured by a separate component from the cylinder 10 or may be integrally formed with the inner wall of the cylinder 10.

At the time of the engine operation, the piston 14 abuts on the stopper 250. The volume A1 of the first space 31 of the cylinder 10 when the piston 14 abuts on the stopper 250 is set as the first volume when operating B1. The stopper 250 is provided at a position at which the first volume when operating B1 is greater than the required recovery volume D (see FIG. 1). Here, since the urging force of the urging portion 215 is set at the lowest pressure value among the engine conditions for stopping the engine and recovering the fuel, it is possible to make the piston 14 surely abut on the stopper 250 at the time of the engine operation.

According to the present embodiment, at the time of the engine operation, the piston 14 abuts on the stopper 250 provided in the second space 32. The stopper 250 is provided at a position at which the volume A1 (the first volume when operating B1) of the first space 31 of the cylinder 10 becomes greater than the required recovery volume D when the piston 14 abuts on the stopper 250. As a result, it is possible to stably secure the first volume when operating B1 of a desired magnitude at the time of the engine operation, without being affected by fluctuations in pressure in the fuel tank 2. Therefore, at the time of the engine stop, all the residual fuel can be recovered more reliably.

### Third Embodiment

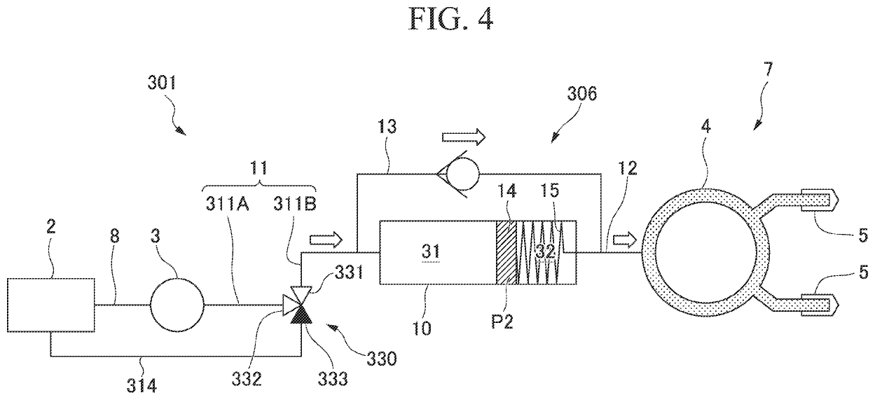

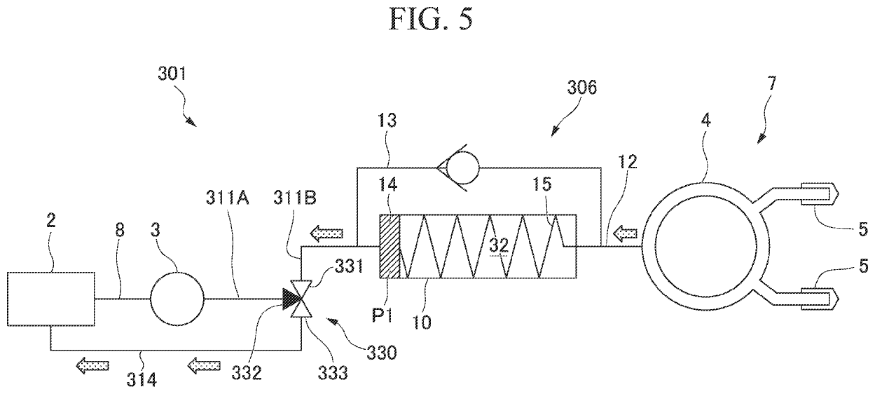

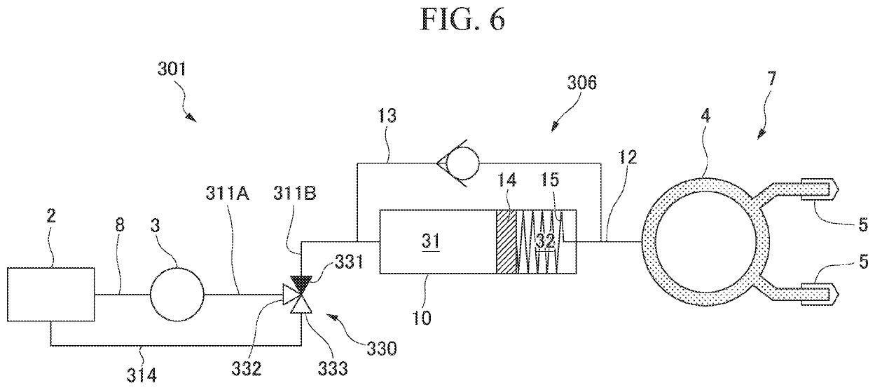

Next, a third embodiment according to the present invention will be described. FIG. 4 is a schematic configuration diagram of the fuel supply system 301 according to the third embodiment. FIG. 5 is a diagram showing the operation of the fuel supply system 301 according to the third embodiment at the time of the fuel recovery. FIG. 6 is a diagram showing the operation of the fuel supply system 301 according to the third embodiment at the time of the engine stop for a short time. In the following description, the same configurations as those in the first embodiment described above will be denoted by the same reference numerals, and the description thereof will not be provided as appropriate. The present embodiment is different from the first embodiment in that the fuel supply system 301 is further provided with a fourth passage 314 and a three-way valve 330, and at the time of the engine stop for a short period of time, an operation different from that of the above-mentioned normal engine stop is performed.

As shown in FIG. 4, in the present embodiment, the fuel supply system 301 further includes a fourth passage 314 and a three-way valve 330 in addition to the configuration of the first embodiment described above.

The fourth passage 314 branches off from the first passage 11 and is connected to the fuel tank 2, on the upstream side of the fuel from a connection point of the first passage 11 with the third passage 13. One end portion of the fourth passage 314 communicates with the first passage 11. The other end portion of the fourth passage 314 communicates with the fuel tank 2. The fourth passage 314 is used as a flow path for fuel to circulate at the time of the fuel recovery. The fuel in the first passage 11 flows into the fourth passage 314. In the following description, in some cases, the upstream side of the connection point of the first passage 11 with the fourth passage 314 may be referred to as a pump-side first passage 311A. A downstream side from the connection point of the first passage 11 with the fourth passage 314 may be referred to as a cylinder-side first passage 311B.

The three-way valve 330 is provided at the connection portion between the first passage 11 and the fourth passage 314. The three-way valve 330 is configured to be able to switch at least the first passage 11 (the pump-side first passage 311A) and the fourth passage 314. The three-way valve 330 includes a first valve 331 (an on-off valve of claims), a second valve 332 (a selection switching valve of claims), and a third valve 333 (a selection switching valve of claims). The first valve 331 controls the circulation of fuel in the cylinder-side first passage 311B. The second valve 332 controls the circulation of fuel in the pump-side first passage 311A. The third valve 333 controls the circulation of fuel in the fourth passage 314. The first to third valves 331, 332 and 333 are integrally formed as the three-way valve 330. The three-way valve 330 is, for example, a mechanical three-way valve capable of switching the open and closed states of each of the valves 331, 332 and 333 in a predetermined combination. The three-way valve 330 may be, for example, an electromagnetic three-way valve capable of independently switching and controlling the open and closed states of each of the valves 331, 332 and 333.

As shown in FIG. 4, when fuel is supplied from the fuel tank 2 to the fuel supply unit 7 via the ecology device 6 (at the time of the engine operation), the three-way valve 330 is controlled such that the fuel flows through the first passage 11 and is supplied to the ecology device 6. Specifically, at the time of the engine operation, the first valve 331 and the second valve 332 of the three-way valve 330 are opened, and the third valve 333 is closed. As a result, the pump-side first passage 311A and the cylinder-side first passage 311B communicate with each other. Further, the circulation of fuel from the first passage 11 to the fourth passage 314 is blocked. As a result, as in the first embodiment, the fuel from the fuel tank 2 circulates in the order of the first passage 11, the third passage 13, and the second passage 12 and is supplied to the fuel supply unit 7.

Next, as shown in FIG. 5, when the fuel remaining in the fuel supply unit 7 is recovered by the ecology device 6 (when the normal engine is stopped), the three-way valve 330 is controlled such that the fuel recovered by the ecology device 6 passes through the fourth passage 314 and return to the fuel tank 2. Specifically, at the time of the normal engine stop, the first valve 331 and the third valve 333 of the three-way valve 330 are opened, and the second valve 332 is closed. As a result, the cylinder-side first passage 311B and the fourth passage 314 communicate with each other. Further, the circulation of fuel to the pump-side first passage 311A is blocked. As a result, the fuel filled in the first space 31 flows in the order of the cylinder-side first passage 311B and the fourth passage 314 and is returned to the fuel tank 2.

Next, as shown in FIG. 6, when the engine is stopped for a short time for some reason (at the time of the engine stop for a short time) from the state in which the engine is operating, the three-way valve 330 is controlled to leave the fuel in the fuel supply unit 7 (not recovered by the ecology device 6) for a quick restart of the engine. Specifically, at the time of the engine stop for a short time, the second valve 332 and the third valve 333 of the three-way valve 330 are opened, and the first valve 331 is closed. As a result, fuel cannot flow out from the cylinder-side first passage 311B to any of the pump-side first passage 311A and the fourth passage 314. In this case, even when the drive of the fuel pump 3 is stopped with the engine stop, because the fuel in the cylinder-side first passage 311B is not discharged, the fuel pressure of the first space 31 is kept high. Therefore, since the volume A2 of the second space 32 does not change, the fuel is not recovered and the fuel remains in the fuel supply unit 7. When restarting the engine, it is possible to quickly start the engine using the fuel remaining in the fuel supply unit 7, by controlling the three-way valve 330 to open the first valve 331 and the second valve 332 and close the third valve 333 in the same manner as the time of the engine operation as described above.

According to the present embodiment, the fuel supply system 301 includes a fourth passage 314 and a three-way valve 330 (a selection switching valve and an on-off valve of claims). The three-way valve 330 is controlled such that the fuel flows through the first passage 11 (the pump-side first passage 311A) at the time of the engine operation, and the fuel flows through the fourth passage 314 at the time of the engine stop. In this way, the flow path through which the fuel flows differs between the time of the engine operation (at the time of supply of fuel) and the time of the engine stop (at the time of recovery of fuel). Therefore, for example, even when a one-way fuel pump 3 is used, the fuel can be supplied and recovered without wearing the pump. Because the supply path and the recovery path of the fuel are different, it is easy to manage the supply amount and the recovery amount of fuel. Therefore, the amount of fuel supplied from the fuel tank 2 to the fuel nozzle 5 can be controlled more precisely.

The plurality of valves (the first valve 331, the second valve 332 and the third valve 333) are an integrated three-way valve 330. Therefore, the above-mentioned effect can be obtained by each of the valves 331, 332 and 333 with a simple configuration. Since it is not necessary to provide a plurality of valves on the passage, the space for installing the valves can be saved and the passage can be shortened. Therefore, it is possible to suppress an increase in weight and an increase in size of the fuel supply system 1.

The three-way valve 330 is provided in the first passage 11, and at the time of the engine stop for a short time, the first valve 331 of the three-way valves 330 is closed. Here, for example, in some cases, the engine may unintentionally misfire and the engine may be stopped for a short time. In such a case, since it is necessary to restart the engine immediately, it is desirable to keep the fuel in the fuel manifold 4 and the fuel nozzle 5 without recovering the fuel. According to the aspect of the present invention, by closing the first valve 331, because the pressure on the fuel tank 2 side is maintained in a high state, the piston 14 does not move to the first port 21 side, even when stopping the engine. Therefore, because the fuel is not recovered and the fuel remains in the fuel manifold 4 and the fuel nozzle 5, the engine can be restarted quickly. Further, the versatility of the fuel supply system 1 can be improved, by switching the presence or absence of the recovery operation in accordance with the length at the time of the engine stop.

The technical scope of the present invention is not limited to the above-described embodiment, and various changes can be made without departing from the spirit of the present invention.

For example, in each of the above-described embodiments, although the total of the volume of the fuel manifold 4 and the volume of the fuel nozzle 5 is set as the required recovery volume D, the present invention is not limited thereto. The required recovery volume D may have a magnitude at least equal to or higher than the volume of the fuel nozzle 5. That is, in the ecology device 6, the volume of the cylinder 10 may be set so that at least the fuel in the fuel nozzle 5 can be recovered at the time of the engine stop. More specifically, the required recovery volume D may be equal to or greater than the volume of the fuel nozzle 5 and equal to or less than the total volume of the fuel manifold 4 and the fuel nozzle 5. However, the configuration of the embodiment in which the total volume of the fuel manifold 4 and the fuel nozzle 5 is set as the required recovery volume D has an advantage in that the fuel in the fuel nozzle 5 can be recovered more reliably, while suppressing the increase in size of the cylinder 10.

The ecology device 6 may separately include, for example, a housing or a case in which the cylinder 10 is held and the first to third passages 11, 12, and 13 are formed.

In the third embodiment, the first to third valves 331, 332, and 333 may be separately connected to each flow path (in the embodiment, the cylinder-side first passage 311B, the pump-side first passage 311A, and the fourth passage 314). However, the configuration of the present embodiment in which the three valves 331, 332, and 333 are integrated as the three-way valve 330 has an advantage in that the number of components can be reduced and the configuration can be simplified.

In the first embodiment and the second embodiment, a valve mechanism corresponding to the first valve 331 shown in the third embodiment may be provided. In this case, these valve mechanisms may be provided integrally with, for example, the fuel pump 3. The valve mechanism may be provided at an arbitrary position on the downstream side of the fuel pump 3 and on the upstream side of the connection point between the first passage 11 and the third passage 13.

A relief valve may be used as the check valve of the claims.

At the time of the engine stop for a short time, in the above-mentioned third embodiment, although the second valve 332 and the third valve 333 of the three-way valve 330 are opened and the first valve 331 is closed, the present invention is not limited thereto. The second valve 332 and the third valve 333 of the three-way valves 330 may be closed and the first valve 331 may be opened. In this case, by opening the second valve 332 at the time of the engine start, it is possible to quickly start the engine using the remaining fuel.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description and is only limited by the scope of the appended claims.

### EXPLANATION OF REFERENCES

1, 201, 301 Fuel supply system
2 Fuel tank
4 Fuel manifold
5 Fuel nozzle
6, 206, 306 Ecology device
10 Cylinder
11 First passage
12 Second passage
13 Third passage
14 Piston
15, 215 urging portion
21 First port
22 Second port
25 Check valve
31 First space
32 Second space
250 Stopper
314 Fourth passage
330 Three-way valve
331 First valve (on-off valve)
332 Second valve (selection switching valve)
333 Third valve (selection switching valve)
A1 Volume of first space
A2 Volume of second space
B1 First volume when operating
D Required recovery volume

What is claimed is:

1. A fuel supply system of a gas turbine engine, the fuel supply system comprising:
a fuel tank;
a fuel manifold which supplies a fuel from the fuel tank to a fuel nozzle; and
an ecology device provided between the fuel tank and the fuel manifold to recover the fuel from the fuel manifold,
wherein the ecology device includes
a first passage connected to the fuel tank,
a second passage connected to the fuel manifold,
a cylinder which is provided between the first passage and the second passage and has a first port communicating with the first passage and a second port communicating with the second passage,
a piston which partitions an internal space of the cylinder into a first space communicating with the first passage and a second space communicating with the second passage, and slides inside the cylinder,
an urging portion which urges the piston from the second port side toward the first port side,
a third passage which branches off from the first passage and communicates with the second passage, and
a check valve which is provided in the third passage to block circulation from the second passage to the first passage,
a volume of the cylinder is equivalent to a total of a volume of the first space and a volume of the second space,
the volume of the first space of the cylinder at the time of engine operation of the gas turbine engine is defined as a first volume when operating, and
when a total volume in the fuel manifold and the fuel nozzle is set as a required recovery volume at the time of engine stop of the gas turbine engine,
the first volume when operating is greater than the required recovery volume.

2. The fuel supply system according to claim 1, wherein the first volume when operating is determined by a balance between a pressure difference between the first space and the second space and a urging force of the urging portion at the time of the engine operation, and
a magnitude of the urging force of the urging portion is set such that the first volume when operating is greater than the required recovery volume.

3. The fuel supply system according to claim 1, further comprising:
a stopper which is provided in the second space and restricts the movement of the piston to the second port side,
wherein the piston abuts on the stopper at the time of the engine operation,
the volume of the first space of the cylinder when the piston abuts on the stopper is defined as the first volume when operating, and
the stopper is provided at a position at which the first volume when operating becomes greater than the required recovery volume.

4. The fuel supply system according to claim 1, wherein the first volume when operating has a magnitude equivalent to the required recovery volume.

5. The fuel supply system according to claim 1, further comprising:
an on-off valve provided in the first passage,
wherein the on-off valve is closed at the time of the engine stop for a short time.

6. The fuel supply system according to claim 1, further comprising:
a fourth passage which branches off from the first passage and is connected to the fuel tank; and
a selection switching valve which is able to switch the first passage and the fourth passage,
wherein at the time of the engine operation, the selection switching valve is controlled such that the fuel circulates through the first passage and is supplied to the ecology device, and
at the time of the engine stop, the selection switching valve is controlled such that the fuel recovered by the ecology device flows through the fourth passage and is returned to the fuel tank.

7. The fuel supply system according to claim 5, further comprising:
a fourth passage which branches off from the first passage and is connected to the fuel tank; and
a selection switching valve which is able to switch the first passage and the fourth passage,
wherein at the time of the engine operation, the selection switching valve is controlled such that the fuel flows through the first passage and is supplied to the ecology device,
at the time of the engine stop, the selection switching valve is controlled such that the fuel recovered by the ecology device flows through the fourth passage and is returned to the fuel tank, and
a three-way valve in which the on-off valve and the selection switching valve are integrated is provided at a connection portion between the first passage and the fourth passage.
